(19) United States
(12) Patent Application Publication
(10) Pub. No.: US 2007/0133527 A1
(43) Pub. Date: Jun. 14, 2007

(54) COMMUNICATION OF DATA TO COMMUNICATION DEVICES

(75) Inventors: Pekka Kuure, Espoo (FI); Markku Vimpari, Oulu (FI)

Correspondence Address: MORGAN & FINNEGAN, L.L.P., 3 WORLD FINANCIAL CENTER, NEW YORK, NY, 10281-2101, US

(73) Assignee: NOKIA CORPORATION, Espoo (FI)

(21) Appl. No.: 11/610,272

(22) Filed: Dec. 13, 2006

(30) Foreign Application Priority Data
Dec. 14, 2005 (GB) GB0525441.2

(51) Int. Cl. H04L 12/56; H04J 3/22

(52) U.S. Cl. 370/389; 370/465

(57) ABSTRACT

An application server for controlling communication of packet data with a plurality of communication devices in a multicasting session is disclosed. The application server is configured for receiving information regarding a packetization parameter that is desired by at least one of the communication devices for reception of packet data, for assigning a different value for the packetization parameter for use in a multicasting session, and for controlling communication of packet data to the plurality of communication devices in the multicasting session based on the different packetization parameter.

### FIELD OF THE INVENTION

The invention relates to communication of data, and more particularly to communication of packet data to a plurality of communication devices.

### BACKGROUND OF THE INVENTION

A communication device can be used for communication with other communication devices. Typically communication devices are used for communication via a communication system for enabling the users thereof to receive and transmit communication such as speech and data. A communication system can be seen as a facility that enables communication sessions between two or more entities such as the communication devices and/or other nodes associated with the communication system. Subscribers, such as the users or end-users, to a communication system may be offered and provided numerous services via their communication devices. Non-limiting examples of these services include two-way or multi-way calls, data communication or multimedia services or simply an access to a data communications network system, such as the Internet. The services may be offered by an operator of a network of the communication system or by an external service provider.

Examples of communication systems include fixed line communication systems, such as a public switched telephone network (PSTN), wireless communication systems, such as a public land mobile network (PLMN), and (wireless) local area networks (LAN; WLAN). From these the PLMNs are commonly based on cellular technology. In cellular systems, a base transceiver station (BTS) or similar access entity services a communication device commonly referred to as a mobile user equipment (UE) or a mobile station (MS) via a wireless interface. The communication on the wireless interface between the communication device and elements of the access system is based on an appropriate communication protocol. The operation of the base station apparatus and other apparatus required for the communication can be controlled by one or several control entities. The various control entities may be interconnected.

One or more gateway nodes may be provided for connecting the cellular network used for accessing the communication system to other networks, for example to a public switched telephone network (PSTN) and/or other communication networks such as an IP (Internet Protocol) and/or other packet switched data networks. In such arrangements, the mobile communications network provides an access network enabling a user to access external networks, hosts, or services offered by specific service providers. In a packet switched data network, a packet data carrier may be established to carry traffic flows over the network.

Various types of services are provided by means of different application servers (AS). The communication may occur over an interface between a gateway node and an external public data network (PDN), such as the Internet. Thus, the application server can operate beyond the network the client is using for the access. Application servers may provide data transfer services to an individual as point-to-point or one-to-one services or group(s) of individuals as point-to-multipoint or one-to-many services. Such groups may be large in number of individuals comprised in the group. In one-to-many services a shared stream of data is simultaneously transmitted to multiple participants. Such communication of data to a number of communication devices is known as multicasting.

An exemplifying service that may be provided by means of an application server is the so-called direct voice communication service. A more particular example of this type of service is the ‘push-to-talk over cellular’ (PoC) service also known as the PTT (push-to-talk service). The direct voice communication services are intended to enable Internet Protocol (IP) connections for user equipments and other parties to the communication. The service allows users to engage in immediate communication with one or more users.

A direct voice communication service may be based on half-duplex Voice over IP (VoIP) technology in cellular networks, for example the GSM/GPRS (Global System for Mobile/General Packet Radio Service) network. The service typically enables a subscriber to listen to group traffic. Calls may be started to both individuals and groups with a simple actuation, such as by a push of a key, voice command or other activation action. The call connection may be established automatically or in response to an appropriate action by the user, i.e. only when so desired. A receiver may not need to answer the call. In the network, a controlling server is usually provided for handling task such as session management and floor control. The controlling server may also be used for controlling tasks such as the multiplying the speech data stream for all members of a group.

Furthermore, a cellular system may include a multimedia broadcast/multicast service (MBMS) server, which is able to broadcast or multicast information to multiple participants over a geographical area. An MBMS server itself is typically not able to form groups, but provides information of different multicasting groups to participants, and is able to send data in the downlink direction to all members of a group.

Use of a PoC application server together with a multimedia broadcast/multicast service (MBMS) server for providing multicast transfer of data in the downlink direction has been suggested. In the uplink direction PoC typically uses Real Time Protocol (RTP) traffic unicast. In the uplink PoC clients send speech data to the PoC application server, which then directs the speech data packets either to the MBMS for the downlink leg to those participants who receive the speech via multicast service or directly to those recipients who prefer to receive via unicast directly from the PoC server. Use of multicast in downlink direction improves the spectral efficiency in the case of group communications with great number of participants. In addition, without multicast it may not be possible to support large group sizes, if the participants are located geographically in the close proximity.

In conventional PoC arrangements the transfer of speech packet data is based on unicast links over the air interface. Procedures and mechanisms are provided for handling the integrity of the data transfer in the air interface. An example of these is a mechanism where received radio blocks are acknowledged by the receiving end. If a certain data block is erroneously received or missing, the acknowledgement message will indicate that and the transmitting end is able to resend the packet. This way, using the re-transmissions over the air interface, the data transfer is relatively reliable and no packet losses occur. This also enables putting more information in each packet and thus it is possible to obtain savings in required air interface data rates as percentage of headers can be reduced from total payload.

With multicast, however, a number of recipients receive the same packet data transfer flow. Some of the recipients may be of close proximity to transmitter (e.g. a base station) while other recipients may reside at the border of the coverage area. As there are numerous recipients but the radio resource is shared by all recipients, it may not be possible to have feedback channels per each recipient. Also, it may not be possible to send any re-transmitted blocks to each recipient separately. This would break the synchronization of the multicast data transfer apart. The result of this is that with multicast some recipients may have an error free or low bit error reception while others receive data with high error rate.

With the Push-to-talk over Cellular (PoC) at its present form, each recipient is receiving the data transfer via unicast links over the radio interface. In order to have better spectral efficiency and to enable the whole service to operate, the required bandwidth needs to be controlled and limited. Typically the bandwidth is reduced by packing more data in each packet, thus reducing the traffic related to transfer of headers, such as IP, UDP and RTP headers. With PoC speech transfer this means that, for example, 10 AMR frames are put in each packet. This means that each packet contains 10×20 ms=200 ms of speech, as each AMR frame corresponds with 20 ms of speech. With this approach and procedure, it is possible to fit PoC speech transfer in a 8 kbit/s packet data channel which further means that the PoC traffic can be fitted into single timeslot, even if a slow modulation and coding scheme is used for the transmission.

However, in a system which does not use re-transmissions, for example a multicast system as discussed above, it is likely that either the Bit Error Rate (BER) or the Block Error Rate (BLER) may become too high. If in that case similar packetization as with the conventional PoC with unicast is used, i.e. 10 AMR frames is included in each packet, the high BER and/or BLER would result a very high frame error rate (FER) in the received audio content. A reason for this is that if there is any bit error in the data packet, the whole packet is discarded. This means that a single bit error results in loss of 200 ms of speech. For audio quality point of view this may be too high for most applications as the FER would be extremely high and propagated.

### SUMMARY OF THE INVENTION

Embodiments of the invention aim to address one or several of the above issues.

In accordance with an aspect there is provided an application server for controlling communication of packet data with a plurality of communication devices. The application server is configured for receiving information regarding a packetization parameter that is desired by at least one of the communication devices for reception of packet data, for assigning a different value for the packetization parameter for use in a multicasting session, and for controlling communication of packet data to the plurality of communication devices in the multicasting session based on the different packetization parameter.

In accordance with an aspect the application server is provided in a system for communication of data. The application server is connected to a packet data network of the data communication system, and at least one communication network is connected to the packet data network. A multicasting server is provided for controlling multicasting of packet data to the communication devices via the at least one communication network.

In accordance with an aspect there is provided a method for communicating packet data with a plurality of communication devices. The method comprises receiving in an application server an indication of a packetization parameter that is desired by at least one of the communication devices for reception of packet data, assigning by the application server a different value for the packetization parameter for use in a multicasting session, and multicasting packet data to the communication devices in the multicasting session based on the different value of the packetization parameter.

In accordance with a more specific aspect, the application server is configured for decreasing the value of the packetization parameter from the value offered by a communication device in response to detection that multicasting is to be used. The application server may split data packets and generate new header values for split data packets. The application server may generate the sequence numbers of outgoing data packets such that the generated sequence numbers form successive series of sequence numbers in a stream of data packets. The application server may modify timestamp values of outgoing data packets based on the different value of the at least one parameter. The timestamp values of successive data packets may be modified based on a frame division factor.

The application server may comprise a direct voice communications server configured to send incoming unicast data streams into the multicasting session. The communication system may comprise at least one communication network adapted for wireless communication of packet data.

The embodiments provide a mechanism to improve the quality of the reception in higher error rate condition, such as higher Bit Error Rate (BER) or the Block Error Rate conditions. Certain embodiments may also provide some advantage in that the BER/BLER target does not need to be set to an extremely low value to get the frame error rate (FER) level at an acceptable level, resulting savings in the use of the radio network capacity.

It shall be appreciated that these issues are not limited to any particular communication environment, but may occur in any appropriate communication system.

Various other aspects, embodiments and advantages are described in the following detailed description and in the attached claims.

### BRIEF DESCRIPTION OF THE DRAWINGS

The invention will now be described in further detail, by way of example only, with reference to the following examples and accompanying drawings, in which:

FIG. 1 shows an example of an arrangement in which the embodiments of the invention may be implemented;

FIG. 2 is a flowchart illustrating an embodiment of the invention; and

FIG. 3 is a flowchart illustrating a further embodiment of the invention.

### DETAILED DESCRIPTION OF PREFERRED EMBODIMENTS

Certain embodiments for increasing reliability of transmission of data to multiple receiving communication devices will now be described by way of example with reference to an exemplifying third generation (3G) mobile communication system. It is noted that this is only an example, and that the invention may be embodied in any other suitable form of a communication system. Also, although the following example is given in relation to multicasting based on an OMA (Open Mobile Alliance) specified Push-to-talk over Cellular (PoC) Service, the embodiments are also applicable to other services.

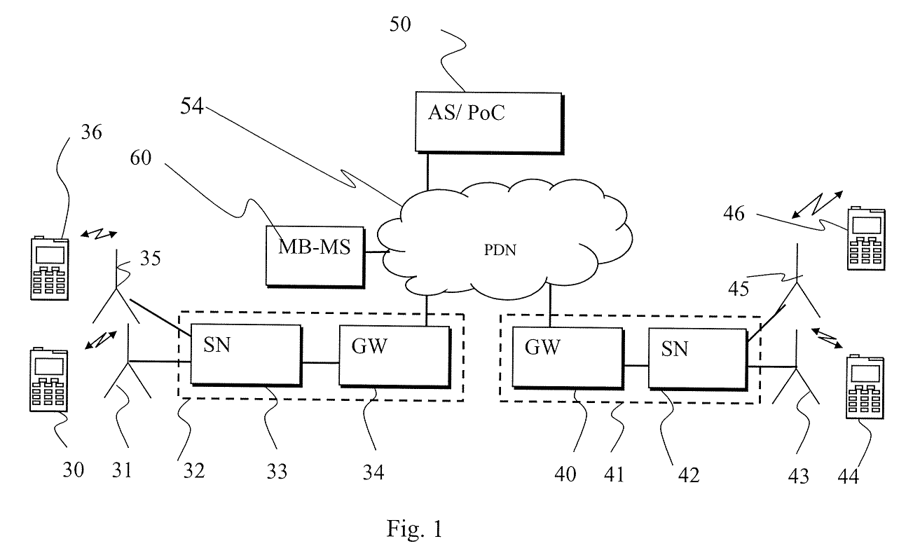

A mobile communication system such as the 3G cellular system is typically arranged to serve a plurality of communication devices that are commonly referred to as mobile stations or user equipments. In FIG. 1, the exemplifying general packet radio services (GPRS) operation environment comprises a plurality of local access areas, which are then interconnected by GPRS back-bone networks 32 and 41. A back-bone network may comprise a number of packet data service nodes (SN). Each of the service nodes 33, 42 is connected to at least one access network, typically to base station systems 31, 35, 43, and 45. Each base station system is arranged to transmit signals to and receive signals from user equipments via respective wireless interfaces. Correspondingly, each of the user equipments is able to transmit signals to and receive signals from the base stations via respective wireless interfaces.

A user equipment can be used for tasks such as making and receiving phone calls, for receiving and sending data from and to the base stations and for experiencing for example multimedia content. User equipment is typically provided with a processor and memory for accomplishing these tasks. User equipment may include an antenna for wirelessly receiving and transmitting signals from and to base stations of the mobile communication network. User equipment may also be provided with a display for displaying images and other graphical information for the user of the mobile user equipment. A speaker may also be provided. The operation of the user equipment may be controlled by means of a suitable user interface such as key pad, voice commands, touch sensitive screen or pad, combinations thereof or the like.

The networks 32 and 41 are connected to an external data network, for example to a packet data network (PDN) 54 via gateway nodes 34, 40. An example of the PDN may comprise, but is not limited to, the Internet Protocol (IP) Multimedia Subsystem (IMS). Overall communication of packet data between a user equipment in an access entity and a gateway may be provided by a PDP context. Each PDP context provides a communication pathway between a particular user/user equipment and a gateway. Once the PDP context is established, it can typically carry multiple flows. Each flow normally represents, for example, a particular service and/or media component of a particular service. The PDP context therefore often represents a logical communication pathway for one or more flows across the network. To implement the PDP context between user equipment and the gateway GPRS support node, radio access bearers need to be established which commonly allow for data transfer for the user equipment. The GPRS system thus allows transmission of packet data between mobile data terminals and/or external data networks and any devices connected to the external networks.

The third generation partnership project (3GPP) has defined it possible to use the general packet radio service (GPRS) for offering internet protocol (IP) connectivity. Session initiation protocol (SIP) as developed by the internet engineering task force (IETF) can be used for signalling such applications. Session initiation protocol (SIP) is an application-layer control protocol for creating, modifying and terminating sessions with one or more participants (end point). SIP was generally developed to allow for the initiation of a session between two or more end points in the Internet by making these end points aware of the session semantics. A user connected to an SIP base communication system may communicate with various entities of the communication system based on standardised SIP messages. User equipment or users that run certain applications on the user equipment are registered with the SIP backbone so that an invitation to a particular session can be correctly delivered to these end points. SIP provides a registration mechanism for devices and users and it applies mechanisms such as location servers and registrars to route the session invitations appropriately. Examples of proper possible sessions that may be provided by SIP signalling include internet multimedia conferences, internet telephone calls and multimedia distribution.

Any appropriate mobile user equipment provided with appropriate transceiver means and adapted for internet protocol (IP) communication can be used to connect to the data network via the mobile system of FIG. 1. For example, user equipment such as a personal computer, personal data assistant (PDA), mobile station (MS), portable computer, combinations thereof or the like can be used.

Furthermore, FIG. 1 shows an application server 50 connected to one or more data networks such as, but not limited to, the exemplifying PDN. It shall be appreciated that a number of application servers may be connected to each data network. In an embodiment the application server 50 may locate in an operator intranet and not behind a public data network 54. For example, an application server may locate in a private network side. The user equipments may connect via the GPRS networks to appropriate application servers 50. Various packet data services may thus be provided for user equipment by means of the capabilities of the GPRS back bone and the control functions of the data network, for example a multimedia subsystem.

An example of such services is the direct voice communication services, for example, push to talk over cellular (PoC) services. A direct voice communication session may be hosted by an appropriate application server, such as server 50 of FIG. 1. The server may be operated by the operator of the IMS system or a third party service provider. The user equipments of FIG. 1 are configured to enable use of direct voice communication services. An actuation means that may be required by a push to talk service can be provided, for example, by one of the buttons on the keypad of the mobile station 30 and 44, by a specific key or button such as the type known from “walkie-talkie” devices, or by other means such as voice activation.

Furthermore, FIG. 1 shows a broadcast multicast service centre 60 which provides functions for Multimedia Broadcast/Multicast Service (MBMS) service provisioning and delivery. The service centre 60 may serve as an entry point for MBMS transmissions of a content provider providing broadcast or multicast data to communication devices situated in a geographical area served by the service centre 60. As was explained above, the MBMS may provide information of different multicasting groups to communication devices in the area. For example, if a multicast service server 60 is used in a PoC session, the PoC server 50 may direct unicast transmitted speech packets to the server 60. The PoC server 50 may also direct data to single clients. Where data is sent depends on whether individual clients are known to listen the multicast channels or not.

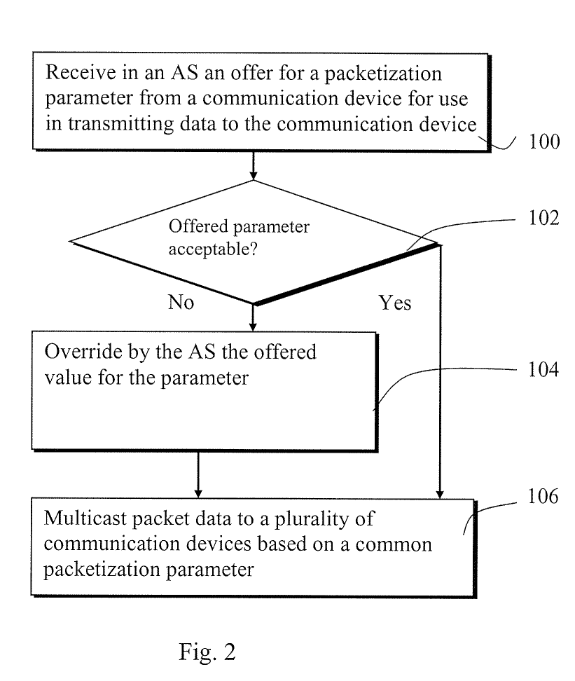

An embodiment of the invention will now be described in more detail with reference to the flowchart of FIG. 2.

A PoC client, for example any of user equipments 30, 36, 44, 46, may negotiate at step 100 appropriate media parameters in any appropriate manner with a PoC server during a PoC session setup phase. The negotiation typically involves sending of media parameters from the PoC client to the PoC server. The PoC client may, for example, suggest use of a certain value of a packetization parameter, for example ten Adaptive Multi Rate (AMR) frames in one Real Time Protocol (RTP) packet with the Session Description Protocol (SDP) of the Session Initiation Protocol (SIP). The PoC client may use a packetization parameter in a SIP message such as ‘ptime 200’ to indicate that it wants to receive 200 ms of speech in each RTP packet. The “ptime” parameter is a media attribute that gives the length of time represented by the media in a packet in milliseconds. The “ptime” attribute does not need to be the same in the uplink and downlink.

After receipt of the request, the PoC server may decide at step 102 if the requested parameters are acceptable. The PoC server may determine that it would be better if the value of the packetization parameter is changed. For example, the PoC server may decide that a different packetization parameter should be used, for example, 20 ms or 40 ms, instead of the requested 200 ms. This would mean either one AMR frame per a RTP packet or two AMR frames in a packet, respectively. This may be desired especially if multicasting is used for a particular session for downlink transfer of data.

The PoC server may then change at step 104 the parameter, for example to insert less AMR frames in each RTP packet for those packets that are then communicated at step 106 to the multicast service server 60. This increases the BLER versus Frame Error Rate (FER) ratio for the multicast transmissions and audio and other data transmissions should become less sensitive to BLER. In other words, the data transmission should become more robust against bad radio conditions.

Reducing the amount of data to be included in each RTP packet increases the required data rate. However, this should provide a more robust audio reception in higher Block Error Rate (BLER) conditions over the non-error corrected multicast link, thus more than compensating the increase. Thus, in a preferred embodiment the client communication devices receive a data rate that is higher than what they initially negotiated. Since the communication devices preferably use unicasting, there is no change in this regard.

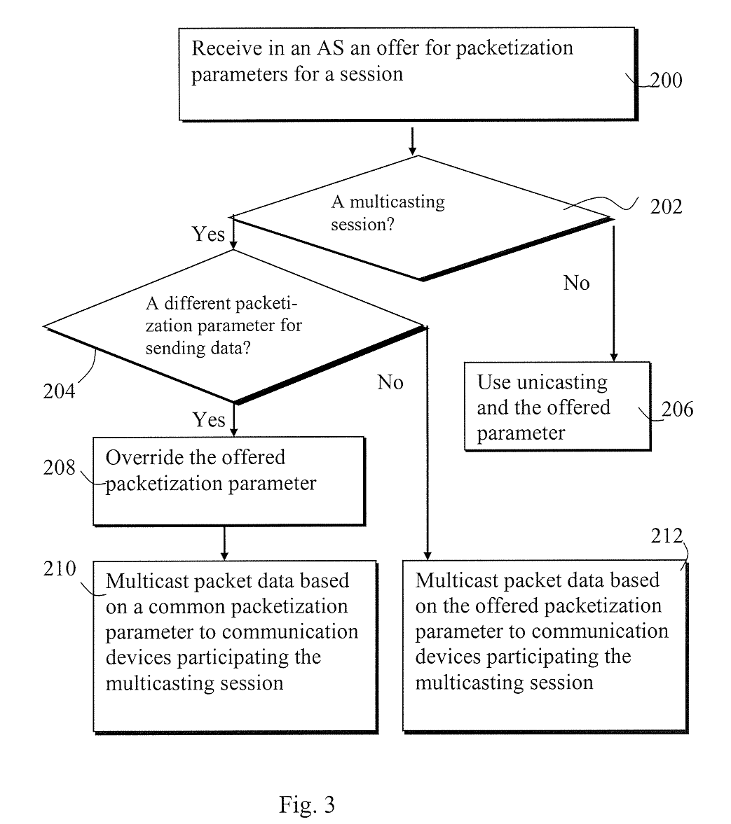

FIG. 3 shows an embodiment wherein an application server changes the value of a media parameter from a value requested by a communication device subsequent to detection that the session is a multicasting session. This may occur, for example, in situation where more clients join a session, and thus the communication scheme may need to be changed from the originally used “normal” scheme.

In accordance with a possibility a communication device that initiates a session sends on offer as “sendrecv” with appropriate parameters. If a “ptime” attribute is included, it means that whoever accepts this offer, should use the “ptime” value in its transmission towards this communication device. At this point the application server may realize that multicast shall be used for the downlink traffic. To address this, the application server can be configured to break the “sendrecv” offer in parts “sendonly” and “recvonly”. This may be needed because of the intention to use different “ptime” values for uplink and downlink directions and also because the addresses for sent and received traffic are different. For example, a communication device may offer sendrecv for a bi-directional stream with ptime attribute, say for example ptime=200. The application server realizes the situation and notices that Client A would like to receive with 200 ms interval/packet size, but that may not be feasible due to fact that server intends to use multicast, where it is more beneficial to use more bandwidth to get more robust transmission and to decrease the Frame Error Rate. Therefore the application server decides to override the request and to use another packetization scheme.

The application server may provide the overriding function in various manners. For example, it may accept the offer, but modify the answer. Another possibility is to accept the offer, but send immediately an update.

The application server may be enabled to decide whether to use multicast or not based on various mechanisms. A possibility would be to detect from a session setup message, such as SIP INVITE or SIP REFER, an indication that multicasting shall be used. Use of multicast for certain sessions may also be pre-configured in the application server so that when it receives a session invitation, it may check if multicasting shall be used. The application server may, for example, be configured to dynamically use multicasting for certain predefined groups for which there is setting “use multicast”. An example is a configuration where a criteria is set on for example the number of participants exceeding a threshold, which would trigger multicasting. After the application server has decided to usemulticast it reserves resources from a MBMS.

Even though the client communication devices may have negotiated a bandwidth and a packetization scheme for the data transfer, and expect to receive packet data accordingly, this does not mean that they are not able to receive a different data rate and differently packetized speech without any significant problems. This is so because parameters associated with, for example, bandwidth and packetization are suggested for operation over a unicast link and assuming certain configuration of radio access network. However in other conditions, for example if reception occurs via a multicast channel the client devices are typically configured such that reception of higher (or lower) data rates is possible. This is so since the client device capabilities, for example data processing and/or memory capabilities, are not the bottleneck but the capacity restriction is typically caused by the radio access layer.

The Real Time Protocol (RTP) division ratio N is a fixed integer value N (e.g. 2 or 4). In such case the PoC server can simply generate a new RTP header value for the split packets. An example of this is explained below.

In accordance with an embodiment the sequence number of each data packet is incremented by one for every outcoming RTP packet. The sequence number for the first new packet would then be (seq*N) mod (2ˆ16), and then (seq*N+1) mod (2ˆ16), (seq*N+2) mod (2ˆ16), where seq is the original sequence number of the packet and N is the division ratio, and so forth for the successive ones until N−1. There is typically no necessity to re-order and buffer the incoming RTP packets, so no additional delay is introduced due to the splitting of the packets.

Each packet is typically provided with a timestamp (TS) value. The timestamp value of the first split packet may be the value received in the incoming RTP packets. In accordance with an embodiment the timestamp value is incremented with the number of samples covered in the new, split packet for the successive ones. A timestamp (TS) step between successive RTP packets is used to describe the length of the packet in the samples. For example, lets assume that a timestamp step of 320 is used for a frame length of 40 ms with the sampling rate of 8000/s, that an incoming RTP packet has a timestamp value of 10000, and that there are 10 AMR frames in the incoming packet and 2 frames are inserted into outgoing packets (i.e. the division ratio N is 5). This results the timestamp values on the outgoing packets to be 10000, 10320, 10640, 10960 and 11280. The next incoming RTP packet will have timestamp value of 11600 (i.e. 320+ the TS of the last split packet), 160 sample frame length being a typical value for a normal narrowband speech codec, where the timestamp step is 8000 (samples/s)*20 ms=160 samples frame. If a packet contains N frames, the timestamp step is N*160. Thus if N=2, then the timestamp step is 320.

In accordance with an embodiment Forward Error Correction (FEC) encoded transmission can be used if the achieved FER is not good enough. FEC is advantageous in that it provides extra data that can then be used in the receiving end to conceal lost packets. This may increase the bandwidth required by the multicast stream, but on the other hand, if the number of users listening the stream is high enough, for example more than four in a physical area, it should still be feasible in most instances to use multicast instead of multiple unicasts.

The embodiments may enable robust communications of audio and other data in multicast group communication arrangement. In certain situation the embodiments may even be a way to enable use of multicast as otherwise the quality of the received data may become unacceptable.

The required data processing functions of the servers may be provided by means of one or more data processor entities. An appropriately adapted computer program code product may be used for implementing the embodiments, when loaded to a computing device comprising such a processor. The program code product for providing the operation may be stored on and provided by means of a carrier medium such as a carrier disc, card or tape. A possibility is to download the program code product via a data network. Implementation may be provided with appropriate software in a server.

It is understood that other embodiments of the invention are possible, while remaining within the scope of the invention. It is noted that even though the exemplifying communication system shown and described in more detail in this disclosure uses the terminology of the 3^{rd} generation (3G) WCDMA (Wideband Code Division Multiple Access) networks, such as the GSM, UMTS (Universal Mobile Telecommunications System) or CDMA2000 public land mobile networks (PLMN), embodiments of the proposed solution can be used in any communication system providing wireless access for users thereof, for example on a (wireless) local area network (LAN or WLAN) environment.

Whilst embodiments of the present invention have been described in relation to communication devises such as mobile stations, embodiments of the present invention are applicable to any other suitable type of communication devices. Furthermore, the invention is not limited to OMA PoC environments.

It is also noted herein that while the above describes exemplifying embodiments of the invention, there are several variations and modifications which may be made to the disclosed solution without departing from the scope of the present invention as defined in the appended claims.

1. An apparatus for controlling communication of packet data with a plurality of communication devices, the apparatus comprising: an application server being configured for receiving information regarding a packetization parameter that is desired by at least one of the communication devices for reception of packet data, for assigning a different value for the packetization parameter for use in a multicasting session, and for controlling communication of packet data to the plurality of communication devices in the multicasting session based on the different packetization parameter.

2. An apparatus as claimed in claim 1, wherein the application server is further configured to assign the different packetization parameter in response to detection that packet data is to be sent in a multicasting session to communication devices.

3. An apparatus as claimed in claim 1, wherein the application server is further configured to decrease the value of the packetization parameter from a value in which at least one of the communication devices desires to receive.

4. An apparatus as claimed in claim 1, wherein the application server is further configured to split data packets in response to detection that packet data is to be sent in a multicasting session to communication devices.

5. An apparatus as claimed in claim 4, wherein the application server is further configured to split real time protocol data packets and to generate new header values for the split real time protocol data packets.

6. An apparatus as claimed in claim 4, wherein the application server is further configured to generate sequence numbers for outgoing split data packets such that the generated sequence numbers form successive series of sequence numbers in a stream of data packets.

7. An apparatus as claimed in claim 1, wherein the application server is further configured to modify timestamp values of outgoing data packets based on the different packetization parameter.

8. An apparatus as claimed in claim 7, wherein the timestamp values of successive data packets are modified based on a frame division factor.

9. An apparatus as claimed in claim 1, wherein the application server is further configured to use multicasting for an at least one predefined group of communication devices.

10. An apparatus as claimed in claim 1, wherein the application server is further configured to use multicasting in response to detection that the number of communication devices participating in a session exceeds a threshold.

11. An apparatus as claimed in claim 1, wherein the application server is configured to use multicasting in response to a request from a communication device.

12. An apparatus as claimed in claim 1 wherein the application server is further configured for communication of audio data.

13. An apparatus as claimed in claim 1 wherein the application server further comprises a direct voice communications server configured to send incoming unicast data streams into the multicasting session.

14. An apparatus as claimed in claim 13, wherein the application server further comprises a Push-to-talk over Cellular server.

15. An apparatus as claimed in claim 1 wherein the application server further comprises an interface for sending said packet data to a multicast server.

16. A system for communication of data comprising an apparatus as claimed in claim 1, the system further comprising:
a packet data network, the application server being connected to the packet data network;
at least one communication network connected to the packet data network; and
a multicasting server for controlling multicasting of packet data from the application server to the communication devices via the at least one communication network.

17. A system as claimed in claim 16, wherein the at least one communication network is adapted for wireless communication of packet data.

18. A method for communicating packet data with a plurality of communication devices, the method comprising:
receiving in an application server an indication of a packetization parameter that is desired by at least one of the communication devices for reception of packet data;
assigning by the application server a different value for the packetization parameter for use in a multicasting session; and
multicasting packet data to the communication devices in the multicasting session based on the different value of the packetization parameter.

19. A method as claimed in claim 18, further comprising decreasing the value of the packetization parameter from the value desired by at least one communication device.

20. A method as claimed in claim 18, further comprising splitting data packets and generating a new header value for the split data packets.

21. A method as claimed in claim 18, further comprising generating the sequence numbers of outgoing data packets to form successive series of sequence numbers in a stream of data packets.

22. A method as claimed in claim 18, further comprising modifying timestamp values of outgoing data packets based on the different value of the at least one parameter.

23. A method as claimed in claim 22, further comprising modifying the timestamp values of successive data packets based on a frame division factor.

24. A method as claimed in claim 18, further comprising detection by the application server that multicasting is to be used for communication of data packets to communication devices.

25. A method as claimed in claim 18, wherein the communication devices receiving multicast packet data transmit packet data by way of unicasting.

26. A method as claimed in claim 18, wherein the multicasting comprises multicasting of audio data in data packets over wireless interfaces.

27. A method as claimed in claim 18, wherein the multicasting comprises multicasting data packets in a direct voice communication multicasting session.

28. A method as claimed in claim 27, wherein the multicasting comprises multicasting data packets in a Push-to-talk over Cellular multicasting session.

29. A method as claimed in claim 18, wherein receiving an indication of a desired value of the packetization parameter comprises receiving the indication in a session initiation protocol message.

30. A method as claimed in claim 18, further comprising:
receiving unicast packet data stream in the application server;
sending the packet data stream from the application server to a packet data network and further to at least one communication network serving the communications devices; and
controlling the multicasting of the packet data stream by a multicasting server.

31. An article of manufacture comprising a computer readable medium containing program code that when executed causes a processor to perform the method of claim 18.
